(19) United States
(12) Patent Application Publication
(10) Pub. No.: US 2025/0217145 A1
(43) Pub. Date: Jul. 3, 2025

(54) TECHNIQUES FOR PIPELINING SINGLE THREAD INSTRUCTIONS TO IMPROVE EXECUTION TIME

(71) Applicant: Think Silicon Research and Technology Single Member S.A., Rion Achaias (GR)

(72) Inventors: Dimitrios TSALIAGKOS, Athens (GR); Petros VOUDOURIS, Athens (GR); Georgios KERAMIDAS, Patras (GR)

(73) Assignee: Think Silicon Research and Technology Single Member S.A., Rion Achaias (GR)

(21) Appl. No.: 18/550,566

(22) PCT Filed: Sep. 7, 2023
(86) PCT No.: PCT/GR2023/000046

§ 371 Date: Sep. 14, 2023

(51) Int. Cl. G06F 9/30; G06F 9/38

(52) U.S. Cl. CPC G06F 9/30087; G06F 9/3009; G06F 9/3836

(57) ABSTRACT

A system and method for power and latency reduction in processing thread execution code in a multithreaded architecture is disclosed. The method includes: receiving a plurality of threads, each thread including a plurality of instructions for execution on a core of a plurality of cores of a processing circuitry; detecting in a first thread of the plurality of threads a plurality of subsequent independent instructions; and inserting into an instruction an instruction hint which when executed configures an instruction scheduler of the processing circuitry to serially execute the plurality of subsequent independent instructions.

### TECHNICAL FIELD

The present disclosure relates generally to graphics processors, and specifically to pipelining single thread instructions.

### BACKGROUND

In a multi-threaded processor architecture, a scheduler is a component which dispatches threads for processing. For example, a thread can include multiple instructions, some of which have dependencies (i.e., instruction 1 must write to memory before instruction 2 reads from the same memory), and some of which are independent.

Execution of dependent instructions must occur in a preordained order, otherwise incorrect results are generated, which are also known as data hazards. A data hazard occurs, for example, when a value is read from a memory before a write instruction to that memory is complete.

Certain computer architectures include hazard detection units (DTUs). Generally, data hazards are addressed by software based solutions, for example at the compiler, or by hardware, for example by adding a DTU circuitry to a processor.

For example, a DTU may be configured to detect a data hazard and insert a delay (also called a “nop”—no operation). However, this adds to total processing time.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving a plurality of threads, each thread including a plurality of instructions for execution on a core of a plurality of cores of a processing circuitry. Method may also include detecting in a first thread of the plurality of threads a plurality of subsequent independent instructions. Method may furthermore include inserting into an instruction an instruction hint which when executed configures an instruction scheduler of the processing circuitry to serially execute the plurality of subsequent independent instructions. Other embodiments of this aspect include corresponding computer systems, apparatus, and computer programs recorded on one or more computer storage devices, each configured to perform the actions of the methods.

Implementations may include one or more of the following features. Method may include: generating the instruction to add a number to a hardcoded register, where the number indicates a number of the subsequent independent instructions. Method may include: serially executing a number of subsequent independent instructions which is equal to the number added to the hardcoded register. Method where the hardcoded register is hardcoded to a zero value. Method may include: detecting in a second thread of the plurality of threads a value of a bit indicator, where the bit indicator indicates a number of subsequent instructions; and serially executing the number of subsequent instructions. Method may include: executing an instruction of a second thread of the plurality of threads, in response to completing execution of the plurality of subsequent instructions. Method may include: executing a first instruction of the plurality of subsequent independent instructions at a first clock cycle; and executing a second instruction of the plurality of subsequent independent instructions at a second clock cycle, where the first clock cycle immediately precedes the second clock cycle. Method may include: generating the instruction hint to include a predetermine bit set to a value indicating that a next instruction is an independent instruction. Method may include: detecting that the instruction is of a first category; and setting a number of predetermined bits to a value which indicates a number of next independent instructions based on the first category. Method may include: executing the next independent instructions. Implementations of the described techniques may include hardware, a method or process, or a computer tangible medium.

In one general aspect, non-transitory computer-readable medium may include one or more instructions that, when executed by one or more processors of a device, cause the device to: receive a plurality of threads, each thread including a plurality of instructions for execution on a core of a plurality of cores of a processing circuitry. Medium may furthermore detect in a first thread of the plurality of threads a plurality of subsequent independent instructions. Medium may in addition insert into an instruction an instruction hint which when executed configures an instruction scheduler of the processing circuitry to serially execute the plurality of subsequent independent instructions. Other embodiments of this aspect include corresponding computer systems, apparatus, and computer programs recorded on one or more computer storage devices, each configured to perform the actions of the methods.

In one general aspect, system may include a processing circuitry. System may also include a memory, the memory containing instructions that, when executed by the processing circuitry, configure the system to: receive a plurality of threads, each thread including a plurality of instructions for execution on a core of a plurality of cores of a processing circuitry. System may in addition detect in a first thread of the plurality of threads a plurality of subsequent independent instructions. System may moreover insert into an instruction an instruction hint which when executed configures an instruction scheduler of the processing circuitry to serially execute the plurality of subsequent independent instructions. Other embodiments of this aspect include corresponding computer systems, apparatus, and computer programs recorded on one or more computer storage devices, each configured to perform the actions of the methods.

Implementations may include one or more of the following features. System where the memory contains further instructions which when executed by the processing circuitry further configure the system to: generate the instruction to add a number to a hardcoded register, where the number indicates a number of the subsequent independent instructions. System where the memory contains further instructions which when executed by the processing circuitry further configure the system to: serially execute a number of subsequent independent instructions which is equal to the number added to the hardcoded register. System where the hardcoded register is hardcoded to a zero value. System where the memory contains further instructions which when executed by the processing circuitry further configure the system to: detect in a second thread of the plurality of threads a value of a bit indicator, where the bit indicator indicates a number of subsequent instructions; and serially execute the number of subsequent instructions. System where the memory contains further instructions which when executed by the processing circuitry further configure the system to: execute an instruction of a second thread of the plurality of threads, in response to completing execution of the plurality of subsequent instructions. System where the memory contains further instructions which when executed by the processing circuitry further configure the system to: execute a first instruction of the plurality of subsequent independent instructions at a first clock cycle; and execute a second instruction of the plurality of subsequent independent instructions at a second clock cycle, where the first clock cycle immediately precedes the second clock cycle. System where the memory contains further instructions which when executed by the processing circuitry further configure the system to: generate the instruction hint to include a predetermine bit set to a value indicating that a next instruction is an independent instruction. System where the memory contains further instructions which when executed by the processing circuitry further configure the system to: detect that the instruction is of a first category; and set a number of predetermined bits to a value which indicates a number of next independent instructions based on the first category. System where the memory contains further instructions which when executed by the processing circuitry further configure the system to: execute the next independent instructions. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a processing circuitry for pipelining single thread execution on a parallel processing circuitry, implemented in accordance with an embodiment.

FIG. 2A is an example schematic illustration of a plurality of threads scheduled for consecutive execution, utilized to describe an embodiment.

FIG. 2B is an example schematic illustration of a reduced instruction set computer (RISC) thread execution pipeline, utilized to describe an embodiment.

FIG. 3 is an example schematic illustration of a multi-thread pipeline for pipelining a single thread, implemented in accordance with an embodiment.

FIG. 4 is an example flowchart of a method for inserting hint instructions for pipelined single thread execution, implemented according to an embodiment.

FIG. 5 is an example flowchart of a method for generating a hint instruction for pipelined single thread execution, implemented according to an embodiment.

FIG. 6 is an example flowchart of an additional method for generating a hint instruction for pipeline single thread execution, implemented in accordance with an embodiment.

FIG. 7 is an example schematic diagram of a system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for reducing latency and power consumption in thread execution in a multithreaded architecture. According to an embodiment, a system is configured to detect a plurality of independent instructions in a thread. In an embodiment, two instructions are independent where they do not share a memory, for example, e.g., execution of one instruction does not affect execution of a second instruction.

In some embodiments, where a plurality of independent instructions are detected, processing of the instructions is pipelined by inserting an instruction hint. For example, in an embodiment, the instruction hint is implemented as an instruction writing a value to a hardcoded register, the value indicating the number of consecutive instructions which are independent. According to another embodiment, a bit representation of an instruction is modified to include a value which indicates a number of consecutive instructions, wherein the modification is performed on bits which are not utilized to store data of the instruction.

By implementing such an instruction hint, latency is reduced in processing. This also allows to avoid implementing a hazard detection unit as a hardware circuit, which reduces die size for a microchip. Furthermore, where a hazard detection (DTU) unit is implemented, utilizing the methods disclosed herein allow to power down such a DTU, which results in using less power for processing.

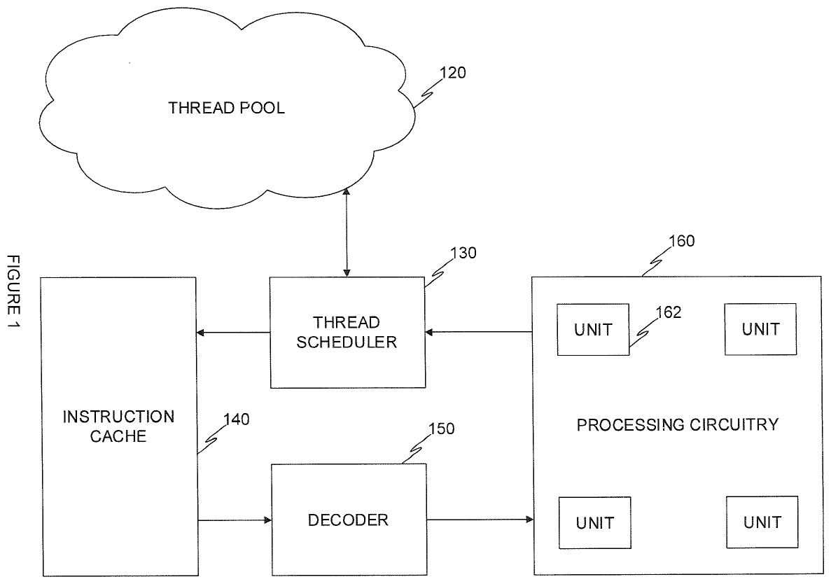

FIG. 1 is an example schematic diagram of a processing circuitry for pipelining single thread execution on a parallel processing circuitry, implemented in accordance with an embodiment.

In certain embodiments, a parallel processing circuitry, such as a graphics processing unit (GPU) or a general purpose GPU (GPGPU), and the like, are processing circuitries which are developed to maximize throughput efficiency of parallel processing operations. Accordingly, when processing a single thread in a sequential manner, such a processing circuitry is wholly unsuited for this purpose, resulting in a bottleneck occurring whenever such a single thread processing is required.

One advantage of the system and methods disclosed is to provide an advanced thread scheduler which is configured to pipeline single thread execution in a manner which would result in accelerated execution, i.e., reduce the number of cycles a single thread requires for execution.

In an embodiment, a thread is selected from a thread pool 120 by a thread scheduler 130. In certain embodiments, a thread pool 120 is a group of threads which have not yet been executed (i.e., processed by a processing circuitry), are being executed, a combination thereof, and the like. In an embodiment, a thread includes a plurality of instructions, and the thread pool 120 includes a data field indicating the next instruction for execution for each thread which is currently being executed (i.e., a first instruction of the thread is being executed in the pipeline, while the next instruction of that thread is indicated by the data field). For example, in an embodiment, a thread pool 120 includes a memory structure which contains therein various threads, each thread including a plurality of instructions.

In some embodiments, a thread scheduler 130 is configured to select a thread from the thread pool 120, and load (e.g., fetch) an instruction of the thread which is selected for execution in the next processing cycle to an instruction cache 140. In some embodiments, the instruction cache 140, and a decoder 150, are included as part of the thread scheduling mechanism.

In an embodiment, the instruction cache 140 is a memory cache, implemented for example on a memory, such as an on-chip memory of a processing circuitry. In certain embodiments, an instruction of a thread, a plurality of instructions of a thread, and the like, are stored in the instruction cache where an instruction is pulled by a fetch unit and provided to a decoder 150.

In an embodiment, a decoder 150 is configured to decode an instruction of a thread. In an embodiment, a decoder 150 is implemented as a circuit, part of a circuit, and the like, which is configured to decode an instruction of a thread, and supply the decoded information to an execution unit of a processing circuitry 160 for processing.

In some embodiments, a processing circuitry 160 includes a plurality of execution units, such as execution unit 162. In an embodiment, a processing circuitry 160 includes a plurality of cores, each core of the processing circuitry 160 including an execution unit 162 and a decoder. In some embodiments, the execution unit 162 is configured to process a thread, a portion of a thread, a plurality of threads, an instruction of a thread, combinations thereof, and the like.

In an embodiment, the pipeline includes a plurality of components, each configured to perform an operation of the pipeline, such as fetch, decode, execute, write to memory, etc.

In certain embodiments, the processing circuitry is realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information. According to an embodiment, at least a portion of the processing circuitry includes a parallel processing circuitry, such as a GPU.

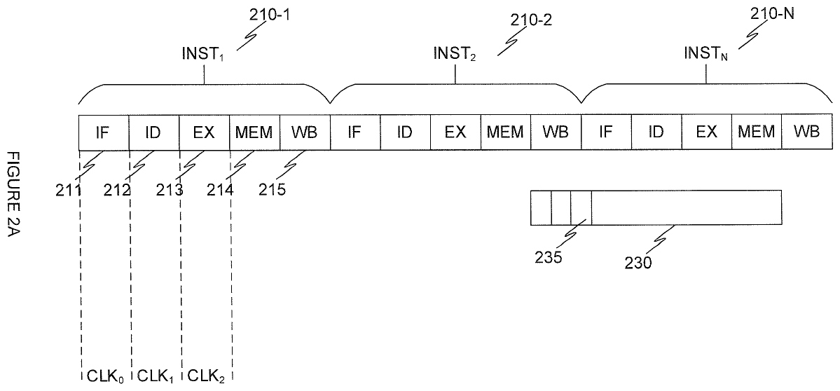

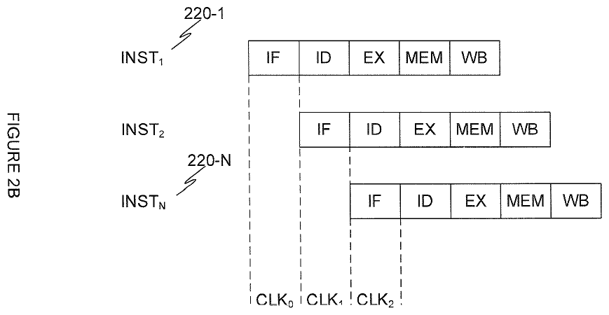

FIG. 2A is an example schematic illustration of a plurality of threads scheduled for consecutive execution, utilized to describe an embodiment. In an embodiment, a plurality of threads 210-1 through 210-N are processed consecutively (i.e., serially, in a non-pipelined manner), such that a first thread 210-1 is completely processed before processing a second thread 210-2.

In an embodiment, a first thread includes a plurality of instructions 210-1 through 210-N, where ‘N’ is an integer having a value of ‘2’ or greater. For example, in an embodiment, the first instruction 210-1 enters a processing pipeline, which includes a fetch operation 211, a decode operation 212, an execution operation 213, a memory access operation 214, and a write back operation 215.

In some embodiments, each instruction takes a different time to execute. In an embodiment, each operation is executed during a processing cycle. For example, at a first cycle the fetch operation 211 of the first instruction 210-1 is executed, at a second cycle the decode operation 212 of the first instruction 210-1 is executed and the fetch operation of the second instruction 210-2 is executed, etc.

This manner of processing is required where instructions are dependent on execution of the previous instructions. However, this presents a disadvantage, where, for example, a first instruction of a thread must be fully processed through the pipeline before a second instruction of the thread can be processed through the pipeline. Therefore, certain embodiments utilize a multi-threading schema, as explained in more detail below, in order to improve pipeline utilization.

In some embodiments, an instruction of a thread is represented by a plurality of bits 230, each having a binary value. In an embodiment, an instruction is classified by an instruction category. For example, in an embodiment, a category of first instructions utilizes all but the first twelve bits, a category of second instructions utilizes all but the last five bits, etc.

In some embodiments, a category is detected based on an indicator bit, a plurality of indicator bits, and the like. In certain embodiments, an instruction hint bit 230 is selected and a value is applied to the instruction hint bit to indicate that a next instruction is an independent instruction, a dependent instruction, and the like. This is discussed in more detail below. For example, in the RISC-V® architecture, the first seven bits of a 32 bit instruction indicate which of the six format types the current instruction is.

FIG. 2B is an example schematic illustration of a reduced instruction set computer (RISC) thread execution pipeline, utilized to describe an embodiment. According to an embodiment, a thread includes a plurality of instructions 220-1 through 220-N, which are processed by a RISC-based processing circuitry in a single pipeline. For example, at a first cycle, the fetch operation of the first instruction 220-1 enters the pipeline for processing. At a second cycle, the decode operation of the first instruction is performed (i.e., enters the next phase of the pipeline), and also at the second cycle the fetch operation of the second instruction 220-2 is performed. This is possible where there is no dependency between the operations of the first instruction 220-1 and the second instruction 220-2 (i.e., the next instruction).

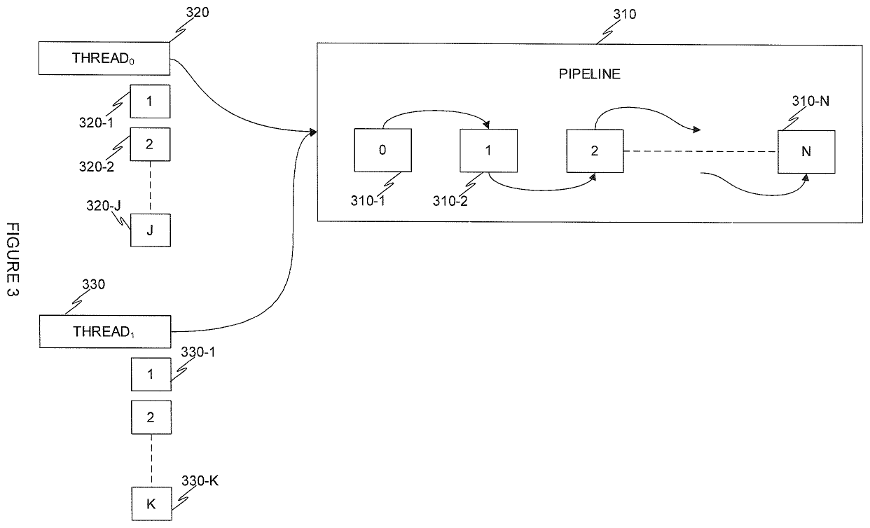

FIG. 3 is an example schematic illustration of a multi-thread pipeline for pipelining a single thread, implemented in accordance with an embodiment. In an embodiment, a first thread 320 includes a plurality of instructions 320-1 through 320-J, where ‘J’ is an integer having a value of ‘2’ or greater. A second thread 330 includes a second plurality of instructions 330-1 through 330-K, where ‘K’ is an integer having a value of ‘2’ or greater.

In an embodiment, the threads are processed by a pipeline 310 of a processing circuitry, for example implemented as a RISC processor. In an embodiment, the pipeline includes multiples stages 310-1 through 310-N, where ‘N’ is an integer having a value of ‘2’ or greater. In certain embodiments, the plurality of stages 310 are executed in a serial manner, such that a first stage 310-1 is utilized prior to a second stage 310-2.

In certain embodiments, in order to avoid hazards, an instruction of a first thread will be processed through the entire pipeline (e.g., stages 310-1 through 310-N) prior to processing the next instruction of the thread. For example, in an embodiment, for a ten-stage pipeline, a first instruction is processed at a first cycle, a second instruction is processed at an eleventh cycle, a third instruction is processed at a twenty-first cycle, and so on. This is done in order to avoid a hazard, which is when two or more instructions conflict. Certain processors include a hazard detection unit, utilized to detect conflicting instructions and ensure that they are executed in a manner which does not cause a conflict.

A hazard detection unit is configured to detect a hazard condition, and generate an instruction, such as a no-operation (nop) instruction, or otherwise deploy instructions, in a manner which avoids the hazard situation, stall the fetch unit of the pipeline, a combination thereof, and the like. Typical hazard situations include a write after write (i.e., two writes are performed to the same register, memory, and the like), write after read, and read after write. In each of these situations, the order in which the instructions are executed matters, because there is dependency. Solutions to avoid hazards include generating bubble (i.e., a no-operation) instructions which allow a first instruction to have time to complete, but add latency. Another solution is to arrange instruction execution in a manner which would eliminate hazards. However, such circuits require die space on a microchip, and further require power to operate. Eliminating a hazard detection unit on a processor, or even bypassing the need to power a hazard detection unit on an existing processor, is therefore advantageous.

In an embodiment, a first single thread 320 includes a plurality of instructions 320-1 through 320-J, where ‘J’ is an integer having a value of ‘2’ or greater, such that a first instruction 320-1 includes a hint instruction, is a hint instruction, and the like. In certain embodiments, a hint instruction configures a processor to schedule a plurality of independent instructions of a single thread in pipelined execution.

For example, in an embodiment, the first instruction 320-1 includes a hint which indicates that the next instruction 320-2 (i.e., second instruction 320-2) is independent of the following instructions up to instruction 320-J. Pipeline processing is therefore, in an embodiment, performed by performing a first operation 310-1 on the first instruction 320-1 at a first cycle, performing a second operation 310-2 on the first instruction 320-1 at a second cycle, and performing the first operation 310-1 on a second instruction 320-2 at the second cycle.

In an embodiment, the instruction hint is generated by adding an instruction to the source or binary code of a thread. For example, in an embodiment, an instruction hint includes a writing of a value, wherein the value indicates the number of consecutive instructions which are independent and can therefore be executed in a pipeline-fashion. In an embodiment, the write instruction is directed to a hardcoded register.

In some embodiments, the instruction hint is generated by detecting a number of unused bits in a current instruction, and writing a value to the unused bits. For example, in an embodiment, an instruction is 32 bits long, of which the first five bits and the last seven bits are not used. In an embodiment, the unused bits are utilized for padding an instruction.

In certain embodiments, the unused bits are provided with a value which indicates a number of consecutive instructions to the current instruction, which are independent instructions. For example, in an embodiment, a first instruction 330-1 of a second thread 330 includes an indicator bit having a value which indicates that unused bits are utilized to indicate a number of consecutive instructions. In an embodiment, there are ‘K’ independent instructions, such that instructions 330-1 through 330-K can be processed in a pipelined fashion, where ‘K’ is an integer having a value of ‘2’ or greater. Pipelining single thread execution allows to reduce latency for processing a single thread, which is advantageous.

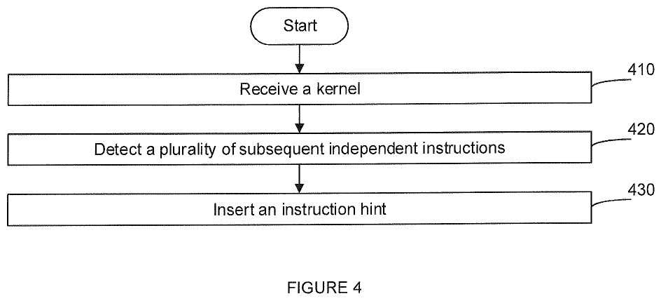

FIG. 4 is an example flowchart of a method for inserting hint instructions for pipelined single thread execution, implemented according to an embodiment. In an embodiment, a thread scheduler is configured to select instructions of a thread for processing based on the hint instruction, and further configure a processor to process instructions of a thread based on the hint instruction.

At S410, a plurality of threads is received. In an embodiment, the threads are stored in a thread pool and retrieved therefrom. A thread pool is implemented, according to an embodiment, as a memory, such as an on-chip memory, an off-chip memory, and the like. In certain embodiments, a kernel is received as a portion of code, which is executed by multiple threads. Each thread operates on different data, but executes the same code on the different data, according to an embodiment.

In some embodiments, each thread includes a plurality of instructions, on each of which pipelined operations are performed. For example, in an embodiment, a thread instruction can be writing to a register, reading a register, performing an operation between integers, performing an operation between numbers stored as floating points, combinations thereof, and the like.

At S420, a plurality of independent instructions are detected. In an embodiment, instructions are independent instructions where execution of one does not affect execution of the other. In certain embodiments, the independent instructions are consecutive instructions of a single thread.

For example, in an embodiment, a first instruction includes adding two integers and writing the result to register “1”, and a second instruction includes reading register “4” and 20 writing the contents of register “4” to register “3”. The first instruction and the second instruction are independent of each other, as execution of one does not affect execution of the other.

As another example, in an embodiment, a first instruction includes reading a value from register “2” and writing the contents to register “3”, while a second instruction includes reading register “3”, adding “2” to the contents of register “3” and writing the result to register “4”. If the second instruction is executed (or execution of the second instructions begins) before processing of the first instruction concludes, the result written to register “4” may be different than if the second instruction is executed after the first instruction has fully executed.

In an embodiment, detecting independent instructions is performed at an application layer, for example by an operating system, application software, and the like, which is configured to detect independent thread instructions. In an embodiment, independent instructions are detected by a compiler which is configured to detect dependent instructions, independent instructions, and the like. In some embodiments, the compiler is further configured to generate a hint instruction, generate a value for bits of an existing instruction to embed a hint, a combination thereof, and the like.

At S430, a hint instruction is inserted. In an embodiment, a hint instruction, when read by a thread scheduler, configures the thread scheduler to execute the independent instructions of a thread in a pipeline fashion, thereby lowering the latency of execution of the thread.

A hint instruction is an instruction in and of itself, according to an embodiment. For example, in some embodiments, a thread has another instruction added to the thread, which is the hint instruction.

In some embodiments, the hint instruction is generated by setting a predefined bit of an existing instruction to an indicating value, whereby the indicating value indicates that a consecutive one or more instructions are independent. This reduces the need, in some embodiments, to generate an additional instruction, and is therefore advantageous.

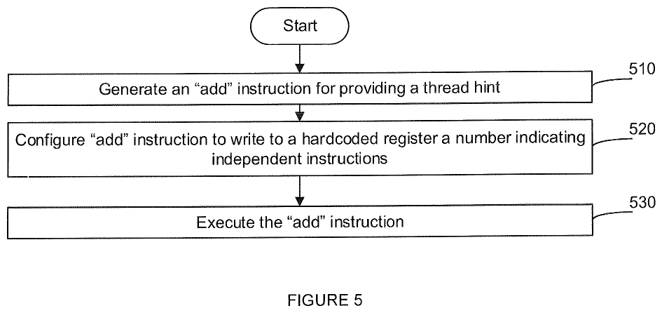

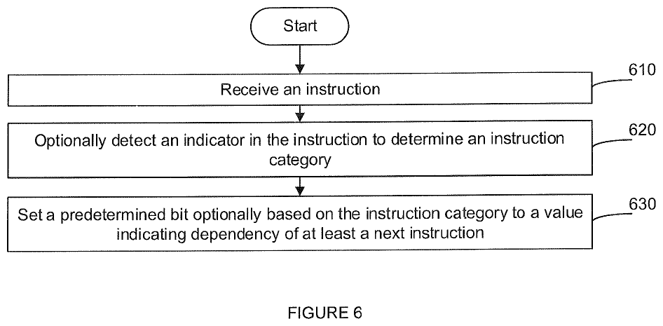

Example methods for generating hint instructions are discussed in more detail with respect to FIGS. 5 and 6 below. In some embodiments, a combination of methods is utilized, for example by generating a hint instruction for some independent instructions, and generating a hint instruction by modifying an existing instruction, for other independent instructions.

FIG. 5 is an example flowchart of a method for generating a hint instruction for pipelined single thread execution, implemented according to an embodiment.

At S510, a write instruction is generated. In an embodiment, generating a write instruction includes generating an add instruction, a move instruction, an arithmetic instruction, and the like. In some embodiments, a write instruction is a write to a register.

For example, in an embodiment, an add instruction is generated based on a predefined format. A predefined format is determined, for example, by the syntax of a language, such as Assembly language, in an embodiment.

In certain embodiments, an add instruction includes a destination register, a first source register, and a second source register. In an embodiment, the destination register of a hint instruction is a register which is hardcoded, for example to a “zero” value. In a RISC architecture, for example, register 0 is hardcoded to a “zero” value, in some embodiments.

In an embodiment, the first source register (or, for example, the second source register) is a number indicating a consecutive number of instructions which are independent. In some embodiments, a source register indicates that the next instruction is a hint instruction, and the next instruction includes a value which represents the number of next consecutive instructions.

In some embodiments, where the maximum number of instructions in a thread is 32 instructions, the maximum number of instructions which can be executed consecutively is 31, as the first instruction is a hint instruction which indicates that the next instructions are independent instructions.

In some embodiments, a hint instruction is detected as a hint instruction by being an instruction which writes a value to a hardcoded register (e.g., writing a value to a hardcoded zero).

At S520, the write instruction is configured. In an embodiment, configuring the write instruction includes adding a value to the instruction which indicates a number of consecutive independent instructions. In an embodiment, the added value which indicates the number of consecutive independent instructions indicates to a thread scheduler, configured to read a hint instruction, that a number of instructions corresponding to the indicator value, are executable in a pipeline fashion (i.e., are independent instructions).

At S530, the write instruction is executed. In an embodiment, executing the write instruction includes configuring a thread scheduler to read the write instruction, and assign a processing core of a processing circuitry to execute a number of instructions which is indicated by the write instruction.

In some embodiments, executing the written instruction includes configuring the scheduler to execute in a pipelined fashion, a number of consecutive independent instructions of the thread, wherein the number is indicated by the write instruction. In an embodiment, where the write instruction is an “add” instruction, values from the first source register and the second source register are added and the result is written to a hardcoded register, thereby, the value of the hardcoded register does not change.

While this processing in and of itself adds to the total number of instructions (e.g., an additional hint instruction needs to be read), where there are more than two consecutive instructions which are independent, the latency is reduced by pipelining the execution, therefore reducing the total time the processing circuitry is active.

FIG. 6 is an example flowchart of an additional method for generating a hint instruction for pipeline single thread execution, implemented in accordance with an embodiment. In certain embodiments, the methods of FIG. 5 and FIG. 6 are combined, so that a portion of hint instructions are generated using the methods of FIG. 5 and a portion are generated utilizing the methods of FIG. 6.

At S610, an instruction is received. In an embodiment, receiving an instruction includes receiving an instruction which is generated based on a predefined RISC schema. For example, in an embodiment, a RISC schema specifies certain predetermined instructions as a data format, such that a first group of bits indicates an operation, a second group of bits indicates a number, a third group of bits indicates a register, etc. In an embodiment, the instruction is an instruction of a thread, selected from a pool of threads.

At optional S620, an indicator is detected. In some embodiments, the indicator is a bit, a plurality of bits, and the like. In certain embodiments, the indicator bit is a bit at a predefined location, an order of predetermined bits, a combination thereof, and the like, in a sequence of bits. In an embodiment, the indicator bit indicates an instruction category. For example, in some embodiments, an instruction category includes a first group of instructions, which are all generated based on a predefined schema. In an embodiment, the predefined schema is a RISC-V architecture.

At S630, a predetermined bit is set to an indicating value. In an embodiment, the predetermined bit is determined by an indicator (e.g., the indicator bit), which indicates a format of the instruction. For example, in an embodiment, the indicating bit indicates that the instruction is of a first group of instructions, where the predetermined bit is at a first location (e.g., bits five through seven of a thirty two bit instruction). In an embodiment, the predetermined bit, indicator bits, and the like, are bits which are not utilized by the instruction.

For example, in an embodiment, the bits are used for padding an instruction. In some embodiments, the predetermined bit, indicator bits, and the like, are set to a value which indicates a number of consecutive instructions which can be executed in a pipelined fashion (i.e., independent instructions).

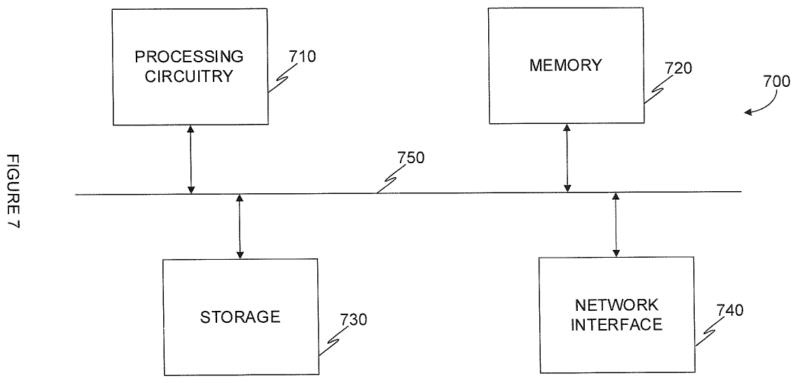

FIG. 7 is an example schematic diagram of a system 700 according to an embodiment. The system 700 includes a processing circuitry 710 coupled to a memory 720, a storage 730, and a network interface 740. In an embodiment, the components of the system 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

In an embodiment, the processing circuitry 710 incudes a thread scheduler 130 such as described in more detail above.

The memory 720 may be volatile (e.g., random access memory, etc.), non-volatile (e.g., read only memory, flash memory, etc.), or a combination thereof. In an embodiment, the memory 720 is an on-chip memory, an off-chip memory, a combination thereof, and the like. In certain embodiments, the memory 720 is a scratch-pad memory for the processing circuitry 710.

In one configuration, software for implementing one or more embodiments disclosed herein may be stored in the storage 730, in the memory 720, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 740 is configured to provide the system 700 with communication with, for example, a network.

It should be understood that the embodiments described herein are not limited to the specific architecture illustrated in FIG. 7, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), GPUs, a memory, and input/output interfaces. The computer platform may also include an operating system and microinstruction code. The various processes and functions described herein may be either part of the microinstruction code or part of the application program, or any combination thereof, which may be executed by a CPU, a GPU, and the like, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for power and latency reduction in processing thread execution code in a multithreaded architecture, comprising:
receiving a plurality of threads, each thread including a plurality of instructions for execution on a core of a plurality of cores of a processing circuitry;
detecting in a first thread of the plurality of threads a plurality of subsequent independent instructions; and
inserting into an instruction an instruction hint which when executed configures an instruction scheduler of the processing circuitry to serially execute the plurality of subsequent independent instructions.

2. The method of claim 1, further comprising:
generating the instruction to add a number to a hardcoded register, wherein the number indicates a number of the subsequent independent instructions.

3. The method of claim 2, further comprising:
serially executing a number of subsequent independent instructions which is equal to the number added to the hardcoded register.

4. The method of claim 3, wherein the hardcoded register is hardcoded to a zero value.

5. The method of claim 1, further comprising:
detecting in a second thread of the plurality of threads a value of a bit indicator, wherein the bit indicator indicates a number of subsequent instructions; and
serially executing the number of subsequent instructions.

6. The method of claim 1, further comprising:
executing an instruction of a second thread of the plurality of threads, in response to completing execution of the plurality of subsequent instructions.

7. The method of claim 1, further comprising:
executing a first instruction of the plurality of subsequent independent instructions at a first clock cycle; and
executing a second instruction of the plurality of subsequent independent instructions at a second clock cycle, wherein the first clock cycle immediately precedes the second clock cycle.

8. The method of claim 1, further comprising:
generating the instruction hint to include a predetermine bit set to a value indicating that a next instruction is an independent instruction.

9. The method of claim 8, further comprising:
detecting that the instruction is of a first category; and
setting a number of predetermined bits to a value which indicates a number of next independent instructions based on the first category.

10. The method of claim 9, further comprising:
executing the next independent instructions.

11. A non-transitory computer-readable medium storing a set of instructions for power and latency reduction in processing thread execution code in a multithreaded architecture, the set of instructions comprising:
one or more instructions that, when executed by one or more processors of a device, cause the device to:
receive a plurality of threads, each thread including a plurality of instructions for execution on a core of a plurality of cores of a processing circuitry;
detect in a first thread of the plurality of threads a plurality of subsequent independent instructions; and
insert into an instruction an instruction hint which when executed configures an instruction scheduler of the processing circuitry to serially execute the plurality of subsequent independent instructions.

12. A system for power and latency reduction in processing thread execution code in a multithreaded architecture comprising:
a processing circuitry; and
a memory, the memory containing instructions that, when executed by the processing circuitry, configure the system to:
receive a plurality of threads, each thread including a plurality of instructions for execution on a core of a plurality of cores of a processing circuitry;
detect in a first thread of the plurality of threads a plurality of subsequent independent instructions; and
insert into an instruction an instruction hint which when executed configures an instruction scheduler of the processing circuitry to serially execute the plurality of subsequent independent instructions.

13. The system of claim 12, wherein the memory contains further instructions which when executed by the processing circuitry further configure the system to:
generate the instruction to add a number to a hardcoded register, wherein the number indicates a number of the subsequent independent instructions.

14. The system of claim 13, wherein the memory contains further instructions which when executed by the processing circuitry further configure the system to:
serially execute a number of subsequent independent instructions which is equal to the number added to the hardcoded register.

15. The system of claim 14, wherein the hardcoded register is hardcoded to a zero value.

16. The system of claim 12, wherein the memory contains further instructions which when executed by the processing circuitry further configure the system to:
detect in a second thread of the plurality of threads a value of a bit indicator, wherein the bit indicator indicates a number of subsequent instructions; and
serially execute the number of subsequent instructions.

17. The system of claim 12, wherein the memory contains further instructions which when executed by the processing circuitry further configure the system to:
execute an instruction of a second thread of the plurality of threads, in response to completing execution of the plurality of subsequent instructions.

18. The system of claim 12, wherein the memory contains further instructions which when executed by the processing circuitry further configure the system to:
execute a first instruction of the plurality of subsequent independent instructions at a first clock cycle; and
execute a second instruction of the plurality of subsequent independent instructions at a second clock cycle, wherein the first clock cycle immediately precedes the second clock cycle.

19. The system of claim 12, wherein the memory contains further instructions which when executed by the processing circuitry further configure the system to:
generate the instruction hint to include a predetermine bit set to a value indicating that a next instruction is an independent instruction.

20. The system of claim 19, wherein the memory contains further instructions which when executed by the processing circuitry further configure the system to:
detect that the instruction is of a first category; and
set a number of predetermined bits to a value which indicates a number of next independent instructions based on the first category.

21. The system of claim 20, wherein the memory contains further instructions which when executed by the processing circuitry further configure the system to:
execute the next independent instructions.
